(19) United States
(12) Patent Application Publication
(10) Pub. No.: US 2019/0329837 A1
(43) Pub. Date: Oct. 31, 2019

(54) PERSON-TRANSPORTING DEVICE

(71) Applicants: Jakob KARBAUMER, Deutschland (DE); Felix BALLENDAT, Deutschland (DE)

(72) Inventors: Felix BALLENDAT, Deutschland (DE); Jakob KARBAUMER, Deutschland (DE)

(21) Appl. No.: 16/475,522

(22) PCT Filed: Dec. 20, 2017
(86) PCT No.: PCT/EP2017/083882

§ 371 Date: Jul. 2, 2019

(30) Foreign Application Priority Data
Jan. 2, 2017 (DE) 10 2017 200 011.2

(51) Int. Cl. B62K 15/00; B62K 3/00; B62K 11/02; B62M 11/02; B60B 19/00

(52) U.S. Cl. CPC B62K 15/006; B62K 3/002; B62K 11/007; B62M 11/02; B60B 19/00; B62K 11/02

(57) ABSTRACT

The invention relates to a person-transporting device (20; 20′) comprising a first and a second ground contact unit (22, 24; 22′, 24′) and comprising a carrier (26) having a first carrier portion (28; 28′) and a second carrier portion (30; 30′), which are articulated to one another; wherein the first ground contact unit (22; 22′) is articulated to the first carrier portion (28; 28′) and the second ground contact unit (24; 24′) is articulated to the second carrier portion (30; 30′), wherein the first carrier portion (28; 28′) is connected to the second ground contact unit (22; 22′) via a first linkage (88; 88′) of the person-transporting device (20; 20′), and the second carrier portion (30; 30′) is connected to the first ground contact unit (22; 22′) via a second linkage (74; 74′) of the person-transporting device (20; 20′).

The invention relates to a person-transporting device comprising two ground contact units.

Person-transporting devices of the type described above usually comprise two mounted wheels, between which a tread surface extends substantially along the wheel axles, which tread surface, in a ready-to-operate state, is held in a horizontal plane by a suitable electronic device which interacts with a drive of the person-transporting device. In order for such person-transporting devices to be easily transported, US 2013/0228385 A1, for example, discloses a folding mechanism for the tread surface, whereby, in a folded state, the distance between the drive wheels is reduced. When the person-transporting device is cornering, the known folding mechanism absorbs transverse forces by means of an arrangement of parallel struts, so that the transverse forces lead to a shearing movement in the arrangement, which is disadvantageous for the stability of the person-transporting device.

It is the object of the present invention to provide a person-transporting device and/or elements of a person-transporting device, which can be arranged in a compact and stable manner.

This object is achieved according to a first aspect of the invention by a person-transporting device comprising a first and a second ground contact unit and comprising a carrier having a first carrier portion and a second carrier portion, which are articulated to each other; wherein the first ground contact unit is articulated to the first carrier portion and the second ground contact unit is articulated to the second carrier portion, characterised in that the first carrier portion is connected to the second ground contact unit via a first linkage of the person-transporting device, and the second carrier portion is connected to the first ground contact unit via a second linkage of the person-transporting device. By the articulation of the carrier portions to each other, the person-transporting device can be folded to save space, while due to the connection of the ground contact unit via a linkage with a carrier portion to which the ground contact unit is not directly articulated, transverse forces may be transmitted from the ground contact unit essentially along the carrier.

It is preferable that a folding state of the person-transporting device is different from an operating state of the person-transporting device.

It is preferred that the carrier is adapted to be folded so that, in a folded state of the person-transporting device, the first carrier portion substantially contacts the second carrier portion, and, in an operating state of the person-transporting device, the first carrier portion lies substantially in one plane with the second carrier portion. By the juxtaposition of the carrier portions in the folded state, a reduction of the size of the person-transporting device is achieved, while their orientation substantially along a plane in the operating state allows an advantageous introduction of force along the carrier, whereby substantially no transversal loading of the carrier occurs.

In a particularly preferred embodiment, the carrier is adapted to be folded so that, in a folded state of the person-transporting device, a distance between the first and the second ground contact unit is smaller than in an operating state of the person-transporting device, whereby, in the folded state, a further reduction of the size of the person-transporting device is achieved.

It is also contemplated that the carrier is adapted so as to be able to be folded so that, in a folded state of the person-transporting device, the first ground contact unit substantially contacts the first carrier portion and the second ground contact unit substantially contacts the second carrier portion, and, in an operating state of the person-transporting device, the first ground contact unit and the second ground contact unit are adapted to carry a load received by the carrier on a surface. By a ground contact unit contacting the associated carrier portion in the folded state, a further reduction of the size of the person-transporting device in the folded state is obtained.

In a particularly preferred embodiment, the carrier may be adapted to be folded so that, in an operating state of the person-transporting device different from a folded state of the person-transporting device, the carrier substantially forms an H-shape with the first and the second ground contact unit, which is preferably not symmetrical in a vertical direction. The H-shape, together with the linkage assembly of the invention, allows the person-transporting device to assume particularly small dimensions in a folded state, wherein an asymmetry in the vertical direction, in which preferably the carrier, which can substantially form the horizontal portion of the H (relative to a centre of the ground contact units), is positioned more downwards, allows one self-stabilising arrangement of a load on the person-transporting device, wherein a tread surface arranged on the carrier can be arranged beneath a pivot axis of a wheel of a ground contact unit.

It is further preferred that the carrier is adapted to be folded so that, in an operating state of the person-transporting device different from a folded state of the person-transporting device, portions of the first carrier portion, of the first ground contact unit, and of the second linkage essentially form a triangular shape or follow in portions a triangular shape and/or portions of the second carrier portion, of the second ground contact unit and of the first linkage essentially form a triangular shape or follow in portions a triangular shape. Due to the triangular configuration, forces which would lead to a pivoting movement of the ground contact unit on the associated carrier portion (the carrier portion to which the respective ground contact unit is articulated), are transmitted by the linkage into the other carrier portion, wherein due to the articulation of the two carrier portions a self-locking of the linkage assembly occurs because the forces transmitted via the linkage lead to a reinforcement of a contact force between contact surfaces of the first and carrier portion.

In a particularly preferred embodiment, the carrier is adapted to be folded so that, in an operating state of the person-transporting device different from a folded state of the person-transporting device, transverse forces transmitted during cornering through the first and/or second ground contact unit to the carrier are transmitted essentially parallel to a running direction of the carrier. Thus, the carrier is preferably loaded in a direction in which it is particularly designed for absorbing a load.

A preferred embodiment of the invention is characterised in that the first carrier portion is articulated to the second carrier portion at a first pivot axis, the first ground contact unit is articulated to the first carrier portion at a second pivot axis and the second ground contact unit is articulated to the second carrier portion at a third pivot axis, wherein the first pivot axis, the second pivot axis and the third pivot axis are aligned substantially parallel to one another, wherein preferably the first and/or the second ground contact unit comprises a separately associated rotary ground contact element, the axis of rotation of which is substantially perpendicular to each of the first, second, and third pivot axes. Due to the fact that the pivot axes substantially perpendicular to the axis of rotation of the rotary ground contact element, it is possible that the person-transporting device in a folded state has a particularly small extension along the axis of rotation of the rotary ground contact element, since a drive of the rotary ground contact unit may be disposed substantially within the inner periphery of the rotary ground contact element, and the carrier portions can be aligned in a folded state substantially parallel to the drive assembly.

It is further contemplated that the first ground contact unit and/or the second ground contact unit are adapted to set the person-transporting device in motion on a surface. Thus, the ground contact unit has an advantageous dual function for load bearing and for driving.

Further, it is possible that the person-transporting device comprises an extendable holder assembly arranged on the carrier, whereby the user can enjoy an increased ease of use due to the presence of a point of application for the hands, while, in the folded state, the size of the holder assembly can be reduced.

According to a second aspect of the invention, which can be combined in any desired manner with the above person-transporting device according to the first aspect, the invention provides a ground contact unit, wherein the ground contact unit comprises a wheel rim and a drive unit, wherein a drive gear and a bearing surface are integrally formed on the wheel rim. Since the wheel rim comprises a drive gear, such as a gear or internal teeth, for transmitting a driving force and at the same time has a bearing surface, which can be a part of a bearing of the ground contact unit, such as in a ball bearing, a roller bearing or similar, a particularly compact arrangement of a drive in the ground contact unit is possible, wherein the integral configuration of the drive gear and of the bearing surface on an element facilitate the reduction of the complexity and thus of the size of the arrangement, since mounting elements can be dispensed with.

In an embodiment, the ground contact unit may be configured in such a way that the bearing surface of the wheel rim forms a first bearing surface and the ground contact unit further comprises a bearing ring having a second bearing surface, wherein the first bearing surface together with the second bearing surface form a common bearing for the bearing bodies. As a result, the bearing surface can be mounted, if necessary, by assembling two components together so that the assembly of the bearing bodies is simplified.

In particular, the ground contact unit may further comprise a wheel hub having a further bearing surface and at least one, preferably a plurality of, bearing bodies, preferably rollers or balls, wherein the bearing surface formed on the wheel rim, the further bearing surface, and the at least one, preferably the plurality of, bearing bodies form a bearing of the ground contact unit such that the bearing bodies are adapted to roll both on the bearing surface of the wheel rim and on the further bearing surface. Thus, a particularly safe and reliable bearing for the wheel rim can be achieved.

It is further contemplated that the ground contact unit comprises a wheel carrier which is adapted to be articulated to a linkage of a person-transporting device and/or to a carrier portion of a person-transporting device, wherein the wheel carrier preferably extends from the wheel rim substantially inward in a radial direction of the wheel rim. Due to the linkage, the above-mentioned advantageous arrangement of the ground contact unit of a person-transporting device may be achieved, so that the corresponding advantages are also transferred to the ground contact unit, and an inwardly extending arrangement of the wheel carrier allows a particularly compact design of the ground contact unit.

Preferably, on the wheel carrier, the drive unit is preferably formed as a drive motor, wherein the drive unit is preferably provided with a drive gear, which preferably engages in the drive gear on the wheel rim. Thus, the motor can be arranged in a space-saving manner, and a space-saving coupling of the drive motor to the wheel rim can be selected.

A third aspect of this invention provides a ground contact unit for a person-transporting device, comprising a wheel hub, a wheel rim, and a bearing assembly, by means of which the wheel rim is rotatably mounted on the wheel hub, wherein the bearing assembly comprises a rolling bearing with a plurality of bearing bodies, which are designed as rolling elements rotating around their own axis of rotation, wherein at least one of the bearing bodies has a radial circumferential recess or a concave peripheral portion. This allows bearing bodies to be guided in a defined manner at the circumferential recess. In addition, with this embodiment, bearing bodies can be produced more simply than many other embodiments, such as balls, because gate marks, centring marks or the like can remain on the respective end faces of the bearing bodies, without influencing the operability of the bearing bodies.

Preferably, the circumferential recess is provided in a central portion of the bearing body. As a result, a good distribution of force over the bearing body can be ensured.

In particular, the ground contact unit may further comprise: a cage having a plurality of cavities for receiving the bearing bodies, wherein the bearing bodies are introduced, in particular clipped, at the circumferential recess, preferably perpendicular to their axis of rotation, into the cavities and are held in the cavities. A particularly secure hold of the bearing body can be achieved by the cage engaging in the circumferential recess, wherein the bearing bodies are preferably secured against loss, for example by a form-fit, or are held in the cavities of the cage with play. As a result, the gap between the adjacent bearing bodies can be reduced and the number of bearing bodies used can thus be increased. In addition, in this embodiment of the bearing assembly, the contact between the rolling surface of the bearing bodies and the cage can be reduced or even completely prevented, so that the operability of the person-transporting device can be improved.

Additionally, or alternatively, the cage may have a plurality of segments in the circumferential direction of the wheel rim, which are interconnected such that they together form the cage. This allows the production and the assembly of the cage to be facilitated.

The ground contact unit according to the third aspect of the invention may advantageously comprise one or more features of the ground contact unit of the second aspect of the invention, and may in particular form an embodiment according to the second aspect of the invention. Furthermore, the ground contact unit according to the third aspect of the invention is advantageously part of a person-transporting device according to the first aspect of the invention.

The invention will be explained in the following with reference to embodiments with the aid of the accompanying figures. In particular:

FIG. 1 is a rear view of an embodiment of a person-transporting device according to the invention in the operating state;

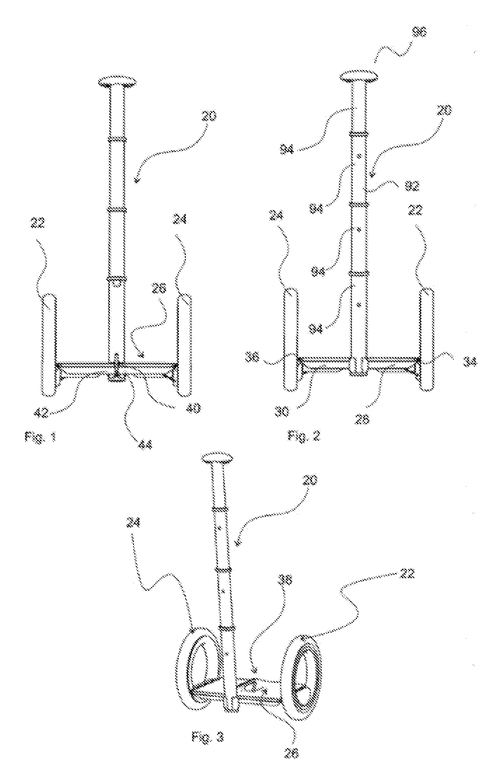

FIG. 2 is a front view of the person-transporting device of FIG. 1;

FIG. 3 is a perspective view of the person-transporting device of FIG. 1;

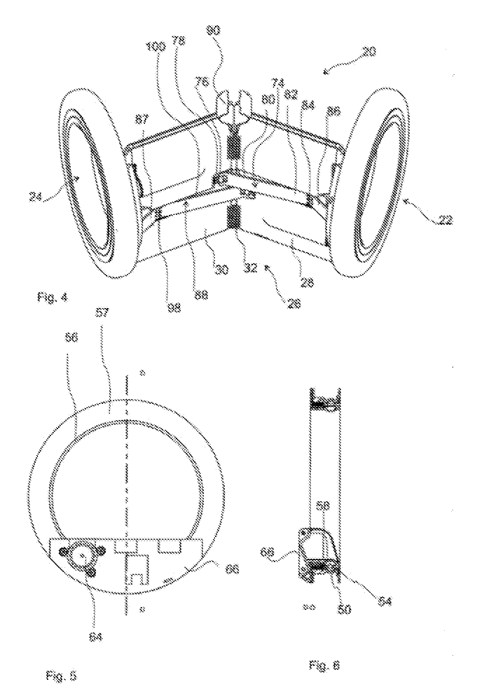

FIG. 4 is a perspective view of the person-transporting device in a partially folded state without telescopic handle of FIG. 1;

FIG. 5 is a side view of a ground contact unit of the person-transporting device of FIG. 1;

FIG. 6 is a D-D section of the ground contact unit of FIG. 5;

FIG. 7 is an exploded view of the ground contact unit of FIG. 5;

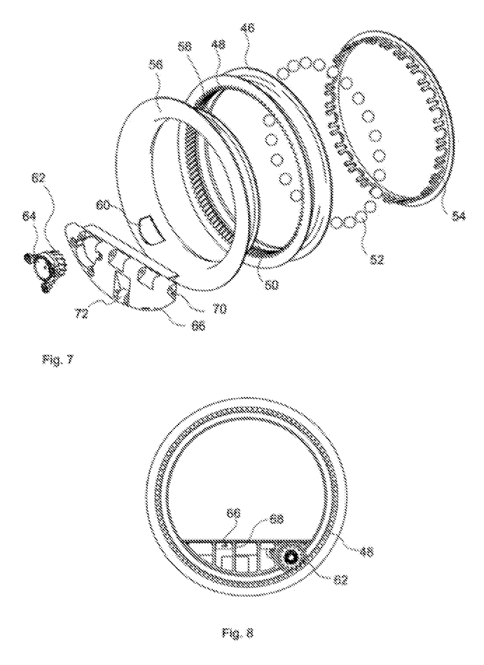

FIG. 8 is a longitudinal section, perpendicular to the axis of rotation of the ground contact unit, the ground contact unit of FIG. 5;

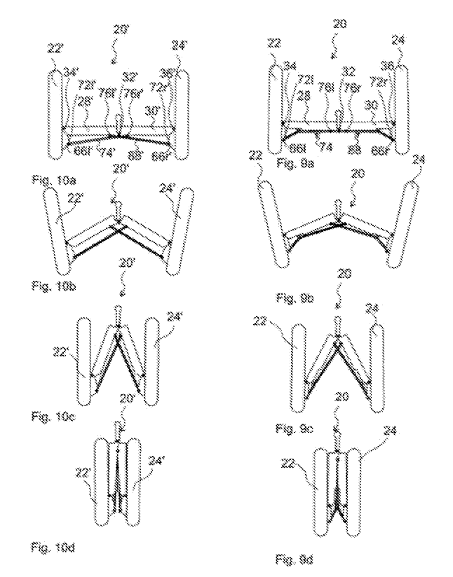

FIG. 9a is a simplified rear view of the person-transporting device from FIG. 1 in the operating state;

FIGS. 9b and 9c are simplified rear views of transition states between the operating state and the folded state of the person-transporting device of FIG. 1;

FIG. 9d is a simplified rear view of the person-transporting device of FIG. 1 in the folded state;

FIG. 10a is a simplified rear view of an alternative embodiment of a person-transporting device according to the invention in the operating state;

FIGS. 10b and 10c are simplified rear views of transition states between the operating state and the folded state of the person-transporting device of FIG. 10a,

FIG. 10d shows a simplified rear view of the person-transporting device of FIG. 10a in the folded state;

FIG. 11 is a side view of another embodiment of the ground contact unit of the person-transporting device according to the invention of FIG. 1;

FIG. 12 shows a B-B section of the ground contact unit of FIG. 11;

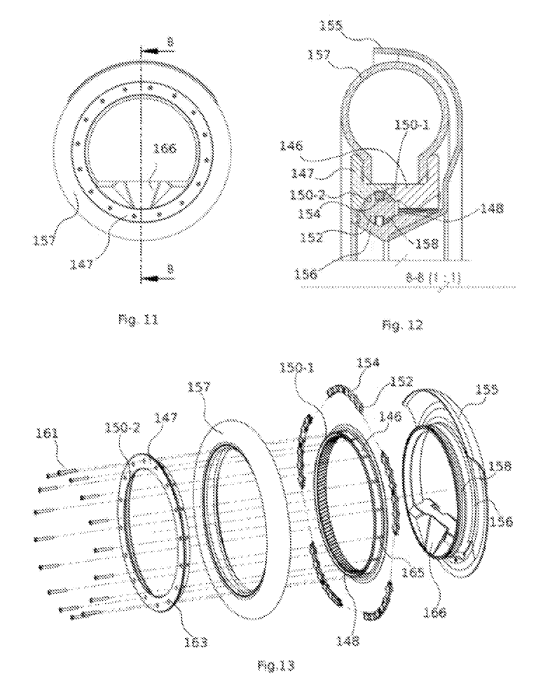

FIG. 13 is an exploded view of the ground contact unit of FIG. 11;

FIG. 14 is a perspective view of a segment of a cage with bearing bodies of FIG. 13 prior to assembly;

FIG. 15 is a side view of a bearing body of FIG. 14;

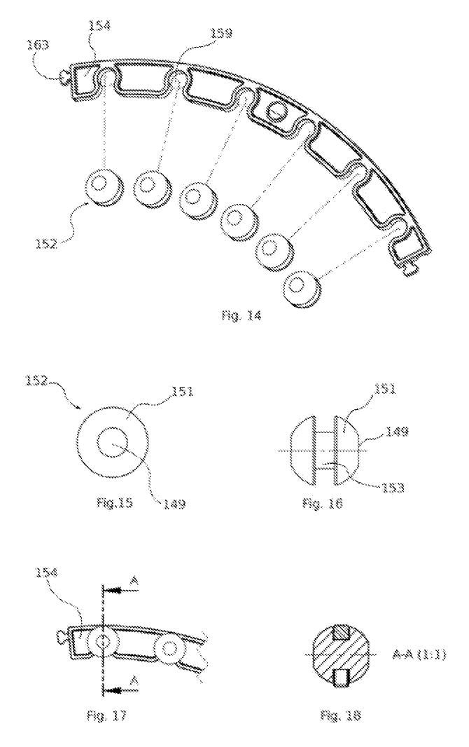

FIG. 16 is a front view of a bearing body of FIG. 14;

FIG. 17 is a side view of a portion of the cage with bearing bodies of FIG. 14 after assembly;

FIG. 18 is an A-A section of the cage with bearing bodies of FIG. 17.

FIG. 1 shows a person-transporting device 20 having a first and second ground contact unit 22, 24, and a carrier 26, which may preferably also represent a tread for a user. The carrier 26 has a first carrier portion 28 and a second carrier portion 30, which are articulated to each other via a joint 32 which is preferably formed as a hinge. The first ground contact unit 22 is articulated to the first carrier portion 28 via a further joint 34 and the second ground contact unit 24 is articulated to the second carrier portion 30 via a joint 36. The first carrier portion is substantially preferably formed symmetrically to the second carrier portion and the first ground contact unit is formed substantially symmetrical to the second ground contact unit, so that in the following the description is essentially limited to the first ground contact unit and the first carrier portion, where appropriate, and corresponding elements and/or features may also be present or formed in the second ground contact unit and the second carrier portion.

Preferably, a tread surface 38 is arranged on an upper side of the carrier 26, which can serve as a standing surface for a user during use of the person-transporting device 20. As a result, a load can be transmitted via the ground contact units 22, 24 to a surface such as a roadway. It is also possible to arrange a handle 40 between the first and second carrier portion, which preferably engages the joint 32, so that by pulling on the handle 40 in an upwards direction, a transition of the person-transporting device is triggered, for example, from an operating state shown in FIG. 3 in a folded state shown in FIG. 9d. The first carrier portion 28 preferably has a first contact surface 42 and the second carrier portion 30 preferably has a second contact surface 44, which are arranged above the joint 32. In the operating state these contact surfaces 42, 44 transmit, preferably via the handle 40, forces to each other and thus a load which acts on the tread surface 38, acts in a self-locking manner with respect to a transition from the operating state to the folded state.

The ground contact unit 22 preferably has a wheel rim 46, on which a drive gear 48, which is an internal gear, and a bearing surface 50 are integrally formed. Preferably, a plurality of bearing bodies 52 lie on the bearing surface 50, which bearing bodies are formed as balls but may also be designed as rollers or the like. The bearing bodies 52 are preferably held by a suitable spacer ring 54 at a suitable distance from each other.

Furthermore, the ground contact unit 22 may have a wheel hub 56, in which preferably a further bearing surface 58 is integrally formed, so that the bearing bodies 52 roll on the bearing surface 50 as well as on the bearing surface 58 of the wheel hub 56. The wheel hub 56 preferably has an opening 60, via which a drive gear 62 attached to a drive 64 (drive unit) can engage in the drive gear 48. The drive 64 is preferably designed as an electric motor, which is preferably fixed by screws in a wheel carrier 66. The wheel carrier 66 is preferably connected to the wheel hub 56 via connecting elements, not shown, such as screws or rivets. Furthermore, a tire 57 (not shown in FIG. 7) is preferably arranged on the wheel rim 46 as a rotary ground contact unit. If the electric motor 64 is supplied with power, it can provide both the propulsion of the person-transporting device in a plane, but it can also be energised by electronics, not shown, in such a way that the tread surface 38 preferably remains aligned in a horizontal direction.

In the context of the present arrangement, the terms front, back, up, down, left, right, horizontal, or vertical refer to an operation-ready arrangement of the person-transporting device 20 on a plane, such as a street or sidewalk.

The wheel carrier 66 is preferably hollow with a series of struts 68 which stiffen the wheel carrier 66.

On the first ground contact unit 22, a joint portion 70, preferably a hinge element, of the joint 34, is preferably provided for articulating the ground contact unit 22 to the first carrier portion 28. Furthermore, a further joint portion 72, preferably a hinge element, of a joint may be provided on the wheel carrier 66, to which a second linkage 74 may be articulated, via which the wheel carrier 66 is connected to the second carrier portion 30. The joint portion 70 may be part of joint 36 on the opposite side and joint portion 72 may be part of a joint or hinge, to articulate the wheel carrier to a first linkage 88 to be described. The joints 36, 34 and 32 are preferably hinges, the pivot axes of which are preferably aligned parallel, wherein, in a plan view, this common orientation of the pivot axes is preferably aligned perpendicular to the axes of rotation of the wheel rims 46 of the first and second ground contact unit.

The second linkage 74 is preferably articulated to a second carrier portion 30 via a joint 76. The second linkage 74 may be articulated in a first cavity 78 in the second carrier portion 30 to the joint 76 and can be at least partially received in a cavity 80 in the first carrier portion 28 so that, in an operating state, the second linkage 74 is arranged at least at a first portion 82 preferably flush with the carrier 26. The second linkage 74 may have a second portion 86 which is articulated to the first portion 82 via an intermediate joint 84 and which is articulated to the joint portion 72. The intermediate joint 84 allows an increased ground clearance over a large area of the person-transporting device 20 compared to a case in which the linkage without the intermediate linkage 84 is connected to the joint 76 with the second carrier portion and to the joint portion 72 of the wheel carrier 66. The intermediate joint 84 is preferably a hinge.

The second linkage 74 preferably connects the second carrier portion 30 to the first ground contact unit 22, which is opposite with respect to the joint 32 which is arranged between the first and second carrier portion.

Preferably, a wheel carrier 66 of the second ground contact unit is connected via a first linkage 88 to the first carrier portion 28 as the wheel carrier 66 of the first ground contact unit is connected to the second carrier portion 30 via the second linkage 74, so that, in order to avoid repetitions, an explicit description is omitted. The first linkage 88 may include elements corresponding to elements of the second linkage 74.

Further, on the person-transporting device, in particular between the first and second carrier portion, a handle holder 90 may be formed integral with the handle 40, which is adapted to hold an extendable holding assembly, designed as a telescopic handle 92. The telescopic handle 92 preferably includes handle segments 94 which can be locked by an indexing device. In order to facilitate the grip on the telescopic handle, a knob 96 may be provided on the telescopic handle 92.

The intermediate joint 84 of the second linkage 74 may be guided in the cavity 80. The guide for the intermediate joint 84 can be formed by an engagement of a shaft of the intermediate joint 84 in a groove in a side wall of the cavity 80. The same can apply to the intermediate joint 98 of the first linkage 88 in the cavity 100.

If the handle 40 is pulled upwards in an operating state, then a folding movement is carried out in which, in the folded state, both the carrier portions abut against each other, and the ground contact units also contact the respective carrier portions to which they are articulated.

The process in which the person-transporting unit transitions from an operating state to a folded state is shown in the simplified illustrations of the person-transporting unit in FIGS. 9a to 9d. In FIGS. 9a to 9d, because of the substantially symmetrical design of the person-transporting unit, the description has been essentially focussed on one side of the linkage or ground contact unit, wherein, as necessary, reference numerals are additionally provided with the letters “l” and “r” to identify a corresponding component, for example the wheel carrier 66, on the left or right side. It can be seen that, in the folded state of the person-transporting device, the first carrier portion 28 contacts the second carrier portion 30, that the first ground contact unit 22 contacts the first carrier portion 28, and the second ground contact unit 24 contacts a second carrier portion 30. In the operating state, the first carrier portion 28 is substantially flush and thus in one plane with the second carrier portion 30. In FIG. 9d it can be seen that the distance of the two ground contact units 22, 24 in the folded state is smaller than in the operating state shown in FIG. 9a. In the operating state, the first linkage 88 is preferably arranged at an angle with respect to the second linkage 74, so that the profiles of the two linkages preferably intersect in a front view.

As best seen in FIG. 1, the first and second ground contact units 22, 24 form an asymmetrical H-shape with the carrier 26, the crossbar being formed by the carrier 26 and being offset downwardly away from a centre of the ground contact units 22, 24, so as to cause the asymmetry. As a result, each individual one of the ground contact units 22, 24 in the folded state can cover substantially the entire surface of the articulated carrier portion 28, 30.

In the embodiment of the person-transporting unit described above, the first linkage 88 and the second linkage 74 each have an intermediate joint 98 and 84. In an alternative embodiment of the person-transporting unit shown in FIGS. 10a to 10d, however, the intermediate bearings can be dispensed with. Otherwise, the discussion of the embodiment described above is also applicable to the alternative embodiment. Elements of the alternative embodiment are provided with reference numerals used for corresponding elements of the embodiment described above but are provided with an apostrophe for differentiating the same. The states of the person-transporting unit shown in FIGS. 10a to 10d substantially correspond to those of FIGS. 9a to 9d.

It should be noted that the first linkage 88′ with the overlying carrier portion 30′ and the ground contact unit 24′, with which the first linkage 88′ is connected, substantially follow a triangular shape in portions. The same applies to the second linkage 74′, the carrier portion 28′ and the ground contact unit 22′. In the above-described embodiment, triangular shapes are formed by the second portion 86 of the second linkage 74, the carrier portion 28 and the ground contact unit 22, and the second portion 87 of the first linkage 88, the carrier portion 30, and the ground contact unit 24, respectively.

This triangular arrangement allows forces, which are generated by a swinging load on the ground contact units 20, 24 and 20′, 24′ at the respective joints 36, 34 and 36′, 34′, to be transmitted substantially parallel to the carrier portions (and thus to the carrier) in the operating state.

Another embodiment of the ground contact unit of person-transporting device is shown in FIGS. 11 to 18. This corresponds essentially to the embodiment according to FIG. 7 and FIG. 8. Therefore, in FIGS. 11 to 18, similar parts are provided with the same reference numerals as in FIG. 7 and FIG. 8, but increased by the number 100. Furthermore, the embodiment according to FIGS. 11 to 18 is described only to the extent that it differs from the embodiment according to FIG. 7 and FIG. 8, whose description is expressly referred to herewith.

A wheel rim 146 has a drive gear 148 and a first bearing surface 150-1. In contrast to the ground contact unit according to FIG. 7 and FIG. 8, the ground contact unit can furthermore comprise a bearing ring 147 which has a second bearing surface 150-2, the first bearing surface 150-1 forming a common bearing for bearing bodies 152 together with the second bearing surface 150-2. In FIG. 13 it is indicated by dashed lines that the bearing ring 147 may be rigidly connected to the wheel rim 146 through screws 161, which are screwed into threaded holes 163 and 165. At the wheel hub 156, a further bearing surface 158 is formed. In addition, the wheel hub 156 may also have a stiffening ring and/or a fender 155.

Another difference compared to the embodiment of FIG. 7 and FIG. 8 is that the bearing bodies 152 have a radial circumferential recess or a concave peripheral portion 153. The bearing bodies each have two opposite rolling surfaces 151 with which the bearing bodies 152 roll on the bearing surfaces 150-1, 150-2 and 158. Furthermore, the bearing bodies 152 can each comprise two opposite front sides 149, perpendicular to the axis of rotation, which have no surface contact with the bearing surfaces 150-1, 150-2 and 158. As a result, the bearing bodies 152 can be produced more simply than many other embodiments, such as balls, because gate marks, centring marks or the like can remain on the respective end faces 149 of the bearing bodies 152, without influencing the operability of the bearing bodies 152.

A cage 154 has a plurality of cavities 159, wherein the bearing bodies 152 are clipped at the circumferential recess 153 perpendicular to their rotation axis into the cavities 159 and are held in the cavities 159. In the embodiment of FIG. 14, the cage 154 engages in the circumferential recess 153, the bearing bodies 152 being held in the cavities 159 of the cage 154 with a form-fit and with play.

The cage 154 may have a plurality of segments in the circumferential direction of the wheel rim 146, which are connected to each other by connecting elements 163 so that they together form the cage 154. The connecting elements 163 have, for example, clips, hooks or latching connections.

1. A person-transporting device comprising:
a first ground contact unit and a second ground contact unit, and
a carrier-having a first carrier portion and a second carrier portion which are articulated to each other;
wherein the first ground contact unit is articulated to the first carrier portion, and the second ground contact unit is articulated to the second carrier portion, characterized in that
the first carrier portion is connected to the second ground contact unit via a first linkage of the person-transporting device, and
the second carrier portion is connected to the first ground contact unit via a second linkage of the person-transporting device.

2. The person-transporting device according to claim 1, wherein the carrier is adapted to be folded so that:
in a folded state of the person-transporting device, the first carrier portion is substantially in contact with the second carrier portion and
in an operating state of the person-transporting device, the first carrier portion lies with the second carrier portion substantially in one plane.

3. The person-transporting device according to claim 1, wherein the carrier is adapted to be folded so that:
in a folded state of the person-transporting device, a distance between the first and second ground contact units is smaller than in an operating state of the person-transporting.

4. The person-transporting device according to claim 1, wherein the carrier is adapted to be folded so that:
in a folded state of the person-transporting device, the first ground contact unit is substantially in contact with the first carrier portion, and the second ground contact unit is substantially in contact with the second carrier portion, and
in an operating state of the person-transporting device, the first ground contact unit and the second ground contact unit are adapted to carry a load received by the carrier on a surface.

5. The person-transporting device according to claim 1, wherein the carrier-is adapted to be folded so that, in an operating state of the person-transporting device different from a folded state of the person-transporting device, the carrier substantially forms an H-shape with the first and the second ground contact unit, which is not symmetrical in a vertical direction.

6. The person-transporting device according to claim 1, wherein the carrier is adapted to be folded so that, in an operating state of the person-transporting device different from a folded state of the person-transporting device, portions of the first carrier portion, of the first ground contact unit, and of the second linkage essentially form a triangular shape or follow in portions a triangular shape and/or portions of the second carrier, of the second ground contact unit and of the first linkage essentially form a triangular shape or follow in portions a triangular shape.

7. The person-transporting device according to claim 1, wherein the carrier is adapted to be folded so that, in an operating state of the person-transporting device different from a folded state of the person-transporting device, transverse forces transmitted during cornering through the first and/or second ground contact unit to the carrier are transmitted essentially parallel to a running direction of the carrier.

8. The person-transporting device according to claim 1, wherein:
the first carrier portion is articulated to the second carrier portion at a first pivot axis,
the first ground contact unit is articulated to the first carrier portion at a second pivot axis, and
the second ground contact unit is articulated to the second carrier portion at a third pivot axis, wherein the first pivot axis, the second pivot axis and the third pivot axis are aligned substantially parallel to one another, wherein the first and/or the second ground contact unit comprises a separately associated rotary ground contact element, the axis of rotation of which is substantially perpendicular to each of the first, second, and third pivot axes.

9. The person-transporting device according to claim 1, wherein at least one of the first ground contact unit or the second ground contact unit is adapted to set the person-transporting device in motion on a surface.

10. The person-transporting device according to claim 1, further comprising an extendable holder assembly-arranged on the carrier.

11. A ground contact unit for a person-transporting, wherein the ground contact unit has a wheel rim and a drive unit, wherein a drive gear and a bearing surface are integrally formed on the wheel rim.

12. The ground contact unit according to claim 11, wherein the bearing surface of the wheel rim forms a first bearing surface, and wherein the ground contact unit further comprises a bearing ring having a second bearing surface, wherein the first bearing surface together with the second bearing surface forms a common bearing for the bearing bodies.

13. The ground contact unit according to claim 11, further comprising a wheel hub having a further bearing surface and at least one, preferably a plurality, of bearing bodies, preferably rollers or balls, wherein the bearing surface formed on the wheel rim, the further bearing surface, and the at least one, preferably the plurality of bearing bodies form a bearing of the ground contact unit such that the bearing bodies are adapted to roll both on the bearing surface of the wheel rim and on the further bearing surface.

14. The ground contact unit-according to claim 11, further comprising a wheel carrier which is adapted to be articulated to at least one of a linkage of a person-transporting device or to a carrier portion of a person-transporting device, wherein the wheel carrier extends from the wheel rim substantially inward in a radial direction of the wheel rim.

15. The ground contact unit according to claim 14, wherein, on the wheel carrier, the drive unit is formed as a drive motor, wherein the drive unit is provided with a drive gear, which preferably engages in the drive gear on the wheel rim.

16. A ground contact unit for a person-transporting device, comprising a wheel hub, a wheel rim, and a bearing assembly, by means of which the wheel rim is rotatably mounted on the wheel hub, wherein the bearing assembly comprises a rolling bearing with a plurality of bearing bodies, which are designed as rolling elements rotating around their own axis of rotation, characterized in that at least one of the bearing bodies has a radial circumferential recess.

17. The ground contact unit according to claim 16, characterized in that the circumferential recess is provided in a central portion of the bearing body.

18. The ground contact unit according to claim 16, wherein the bearing assembly further comprises a cage having a plurality of cavities for receiving the bearing bodies, characterized in that the bearing bodies are introduced at the circumferential recess, in particular clipped, into the cavities and are held in the cavities.

19. The ground contact unit according to claim 18, characterized in that the cage has a plurality of segments in the circumferential direction of the wheel rim, which are interconnected such that they together form the cage.
